(19) United States
(12) Patent Application Publication
(10) Pub. No.: US 2014/0125916 A1
(43) Pub. Date: May 8, 2014

(54) BACKLIGHT MODULE AND DISPLAY APPARATUS

(71) Applicants: Shih Hsiang Chen, Shenzhen (CN); Li-Yi Chen, Shenzhen (CN); Kuangyao Chang, Shenzhen (CN); Dehua Li, Shenzhen (CN); Yong Fan, Shenzhen (CN); Chao Ning, Shenzhen (CN)

(72) Inventors: Shih Hsiang Chen, Shenzhen (CN); Li-Yi Chen, Shenzhen (CN); Kuangyao Chang, Shenzhen (CN); Dehua Li, Shenzhen (CN); Yong Fan, Shenzhen (CN); Chao Ning, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/703,955

(22) PCT Filed: Nov. 22, 2012
(86) PCT No.: PCT/CN12/85004

§ 371 Date: Dec. 13, 2012

(30) Foreign Application Priority Data
Nov. 2, 2012 (CN) 201210431823.0

(51) Int. Cl. G02F 1/1335

(52) U.S. Cl. CPC G02F 1/133524
USPC 349/61

(57) ABSTRACT

The present invention provides a backlight module and a display apparatus. The display apparatus comprises the backlight module and a display panel. The backlight module comprises a light collector, optical fibers, a light guide bar and a light guide plate. The optical fibers are connected between the light collector and the light guide bar. The light guide plate is disposed at one side of the light guide bar. The present invention can use ambient light rays to form a backlight source.

### FIELD OF THE INVENTION

The present invention relates to a backlight module and a display apparatus, and more particularly to a backlight module and a display apparatus using ambient light rays.

### BACKGROUND OF THE INVENTION

Liquid crystal displays (LCDs) have been widely applied in electrical products. Currently, most LCDs are backlight type LCDs that comprise a liquid crystal display panel and a backlight module. According to the position of the light sources for providing LCDs with backlight, the backlight module can be classified into a side-light type or a direct-light type to provide a backlight for the liquid crystal display panel.

In general, light sources of the backlight module are light emitting diodes (LEDs) or cold cathode fluorescent lamps (CCFLs) which need phosphors to form white light rays which have a poorer color performance and a narrower color gamut, and thus it is difficult to achieve a real color of images. Furthermore, the light sources of the backlight module have a high energy consumption, especially for a large-size LCD.

As a result, it is necessary to provide a backlight module and a display apparatus to solve the problems existing in conventional technologies such as above-mentioned.

### SUMMARY OF THE INVENTION

A primary object of the present invention is to provide a backlight module, wherein the backlight module comprises: a light collector configured to collect ambient light rays; at least one optical fiber connected to the light collector; a light guide bar connected to the optical fiber; and a light guide plate disposed at one side of the light guide bar.

A secondary object of the present invention is to provide a backlight module, wherein the backlight module comprises: a light collector configured to collect ambient light rays; at least one optical fiber connected to the light collector; a light guide bar connected to the optical fiber; and a light guide plate disposed at one side of the light guide bar, wherein the at least one optical fiber comprises a plurality of optical fibers, and light-emitting ends of the optical fibers are held to be positioned to a light-incident surface of the light guide bar by a holder, and the light guide bar includes a light-emitting surface and scattering patterns, and the light-emitting surface faces a light input side surface of the light guide plate, and the scattering patterns are formed on a side surface of the light guide bar and opposite to the light-emitting surface.

A further object of the present invention is to provide a display apparatus, wherein the display apparatus comprises a display panel and a backlight module. The backlight module comprises: a light collector configured to collect ambient light rays; at least one optical fiber connected to the light collector; a light guide bar connected to the optical fiber; and a light guide plate disposed at one side of the light guide bar.

In one embodiment of the present invention, the at least one optical fiber comprises a plurality of optical fibers, and light-emitting ends of the optical fibers are held to be positioned to a light-incident surface of the light guide bar by a holder.

In one embodiment of the present invention, the light guide bar is disposed in a short-axis direction or a longitudinal direction of the light guide plate.

In one embodiment of the present invention, the light guide bar includes a light-emitting surface and scattering patterns, and the light-emitting surface faces a light input side surface of the light guide plate, and the scattering patterns are formed on a side surface of the light guide bar and opposite to the light-emitting surface.

In one embodiment of the present invention, the backlight module further comprises a reflective cover configured to cover the light guide bar and to expose a light-incident surface and a light-emitting surface of the light guide bar.

In one embodiment of the present invention, the at least one optical fiber comprises a plurality of optical fibers, and a light-incident surface of the light guide bar is circular, and light-emitting ends of the plurality of optical fibers are arranged in a circular manner.

In one embodiment of the present invention, the at least one optical fiber comprises a plurality of optical fibers, and a light-incident surface of the light guide bar is rectangular, and light-emitting ends of the plurality of optical fibers are arranged in a rectangular manner.

In one embodiment of the present invention, a thickness of the light guide plate is less than a diameter or height of a light-incident surface of the light guide bar.

In one embodiment of the present invention, a thickness of the light guide plate is equal to a height of a light-incident surface of the light guide bar.

In comparison to the problems existing in the conventional backlight module, the backlight module and the display apparatus of the present invention can use the ambient light rays to form the backlight source, thereby greatly reducing an energy consumption of light sources. Moreover, the ambient light can have a wide color gamut, and thus the display apparatus using the backlight module of the present invention can display images of real color for improving a display quality thereof. Furthermore, with the use of the light guide bar of the present invention, the amount of the optical fibers can be reduced to reduce the cost thereof, and a high efficiency for light energy utilization and a slim-bezel design can be achieved.

The structure and the technical means adopted by the present invention to achieve the above-mentioned and other objects can be best understood by referring to the following detailed description of the preferred embodiments and the accompanying drawings:

### DESCRIPTION OF THE DRAWINGS

FIG. 1 is a schematic diagram showing a backlight module according to one embodiment of the present invention;

FIG. 2 is an enlarged view showing a portion of the backlight module according to one embodiment of the present invention;

FIG. 3 is a partially schematic diagram showing the backlight module according to one embodiment of the present invention;

FIG. 4 is a schematic diagram showing the optical fiber according to one embodiment of the present invention;

FIG. 5 is a schematic diagram showing the light guide bar according to one embodiment of the present invention;

FIG. 6 and FIG. 7 are schematic diagrams showing the backlight module according to different embodiments of the present invention;

FIG. 8 is an enlarged view showing a portion of the backlight module according to another embodiment of the present invention; and

FIG. 9 is a schematic diagram showing the light guide bar and the light guide plate according to another embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

In addition, in the specification, unless explicitly described to the contrary, the word “comprise” and variations such as “comprises” or “comprising” will be understood to imply the inclusion of stated elements but not the exclusion of any other elements. Furthermore, in the specification, “on” implies being positioned above or below a target element and does not imply being necessarily positioned on the top on the basis of a gravity direction.

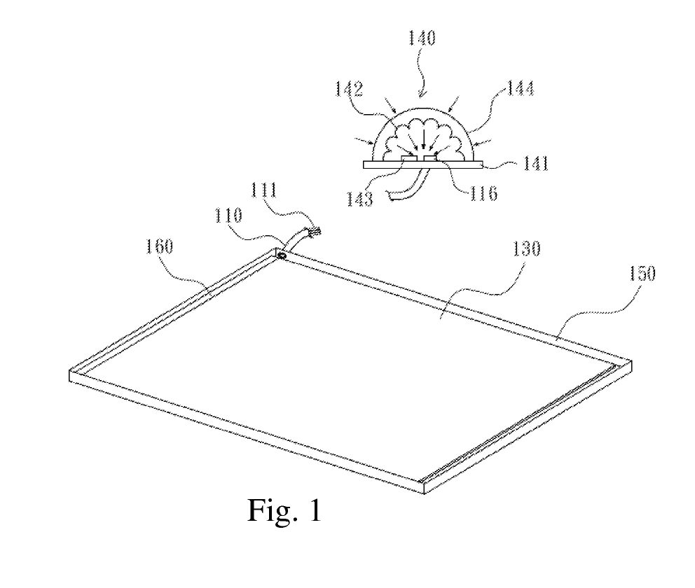

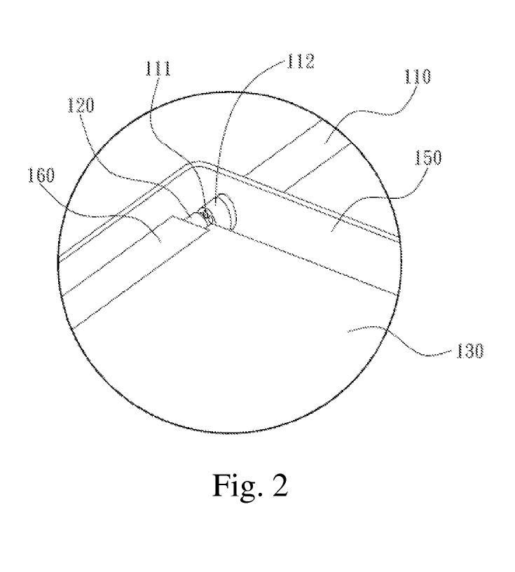

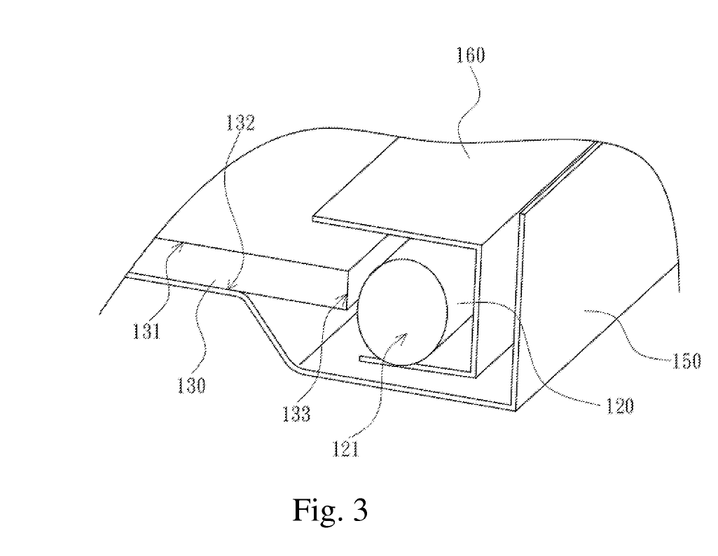

Referring to FIG. 1, FIG. 2 and FIG. 3, FIG. 1 is a schematic diagram showing a backlight module according to one embodiment of the present invention, and FIG. 2 is an enlarged view showing a portion of the backlight module according to one embodiment of the present invention, and FIG. 3 is a partially schematic diagram showing the backlight module according to one embodiment of the present invention. In the present embodiment, the backlight module 100 may be disposed opposite to a display panel (such as a liquid crystal display panel), thereby forming the display apparatus (such as an LCD apparatus). The backlight module 100 comprises a least one optical fiber 111, a light guide bar 120, a light guide plate 130, a light collector 140, a back bezel 150 and a reflective cover 160. The at least one optical fiber 111 is connected between the light collector 140 and the light guide bar 120 for transmitting light rays. The light guide bar 120 is connected to the optical fiber 111 and positioned at one side of the light guide plate 130 for guiding the light rays transmitted by the optical fibers 111 to the light guide plate 130. The light collector 140 is connected to the optical fiber 111 for collecting ambient light rays, such as sunlight or indoor light, so as to provide the light rays for the optical fiber 111. The light guide bar 120 and the light guide plate 130 can be disposed on the back bezel 150. The reflective cover 160 is configured to cover the light guide bar 120 for reflecting the light rays transmitted from the light guide bar 120 to light guide plate 130.

Referring to FIG. 2 again, in the present embodiment, a plurality of optical fibers 111 can be bundled as an optical fiber bundle 110, and the optical fiber bundle 110 can includes a holder 112 for holding light-emitting ends of the optical fibers 111. The holder 112 can be disposed inside the back bezel 150 and facing a light-incident surface 121 of the light guide bar 120, so as to hold the light-emitting ends of the plurality of optical fibers 111 to be positioned to the light-incident surface 121 of the light guide bar 120.

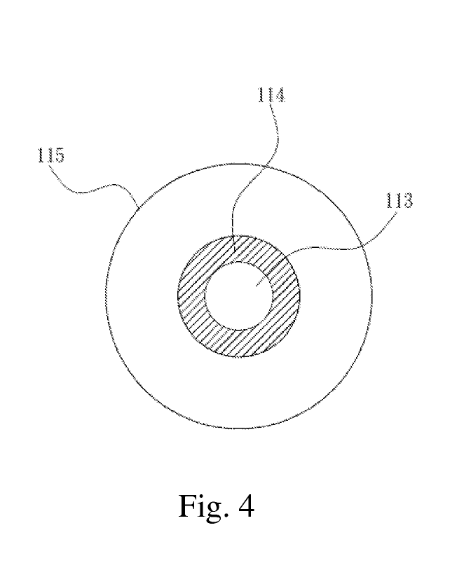

Referring to FIG. 4, a schematic diagram showing the optical fiber according to one embodiment of the present invention is illustrated. Each of the optical fibers 111 may have a fiber core 113, a cladding layer 114 and a buffer layer 115. The fiber core 113 may be made of silica or PMMA for transmitting the light rays. The cladding layer 114 may be made of a hard polymer for cladding the fiber core 113. The buffer layer 115 may be made of tetrafluoroethene for protecting the optical fibers 111 from damage.

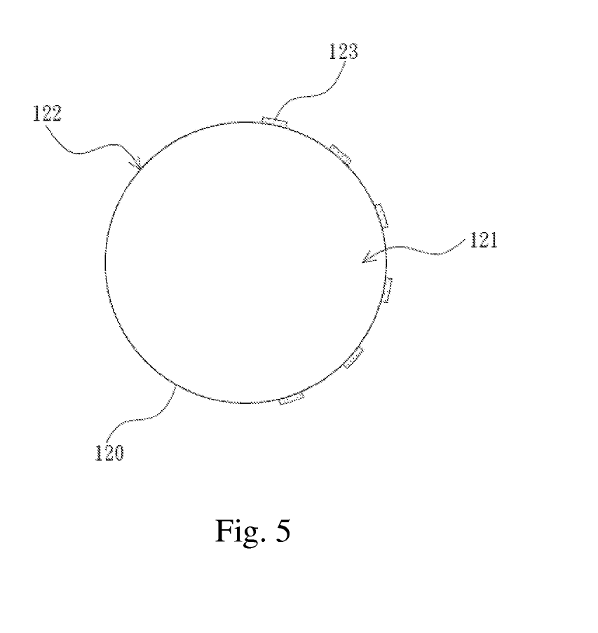

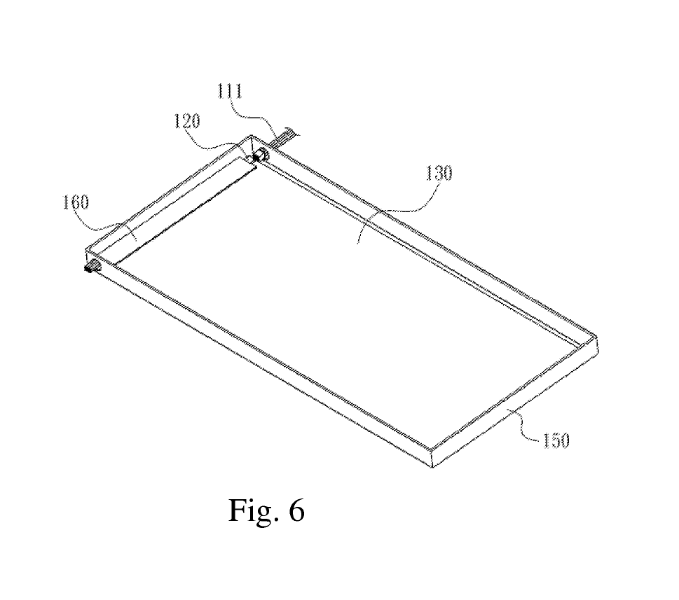

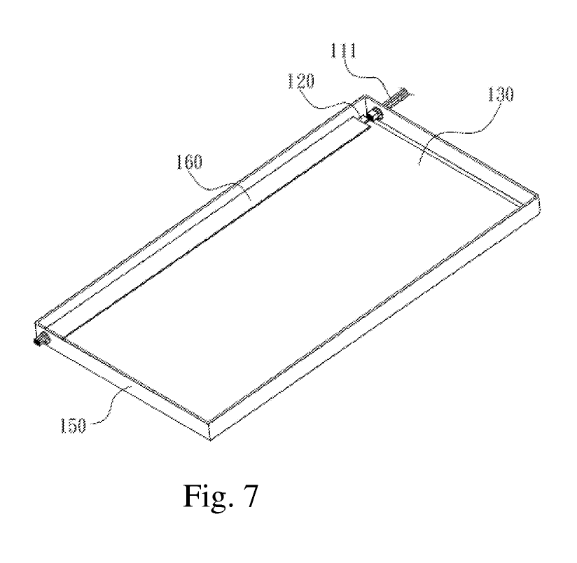

Referring to FIG. 5 through FIG. 7 again, FIG. 5 is a schematic diagram showing the light guide bar according to one embodiment of the present invention, and FIG. 6 and FIG. 7 are schematic diagrams showing the backlight module according to different embodiments of the present invention. The light guide bar 120 of the present embodiment is disposed at one side of the light guide plate 130, such as in a short-axis direction (as shown in FIG. 6) or a longitudinal direction (as shown in FIG. 7) thereof. The light guide bar 120 may be an elongated bar made of photo-curable resin, polymethylmethacrylate (PMMA) or polycarbonate (PC). The light guide bar 120 can include the light-incident surface 121, a light-emitting surface 122 and scattering patterns 123. The light-incident surface 121 is formed at one end of the light guide bar 120 and faces the light-emitting ends of the plurality of optical fibers 111 for receiving the light rays transmitted by the optical fibers 111. The light-emitting surface 122 faces a light input side surface 133 of the light guide plate 130 for transmitting the light rays transmitted by the optical fibers 111. The scattering patterns 123 are formed on the side surface of the light guide bar 120 and opposite to the light-emitting surface 122 for destroying the total reflection of the light rays in the light guide bar 120, such that the light rays can be outputted from the light-emitting surface 122. The reflective cover 160 of the present embodiment may be a U-shaped cover, so as to cover the light guide bar 120 and to expose the light-incident surface 121 and the light-emitting surface 122, thereby ensuring that the light rays inputted from the light-incident surface 121 can be outputted from the light-emitting surface 122.

In this embodiment, the light-incident surface 121 of the light guide bar 120 may be circular. In this case, referring to FIG. 2 and FIG. 5 again, the light-emitting ends of the plurality of optical fibers 111 facing the light-incident surface 121 can be arranged in a circular manner for correspondingly transmitting the light rays to the circular light-incident surface 121. Moreover, a thickness of the light guide plate 130 can be less than a diameter or height of the light-incident surface 121 of the light guide bar 120, so as to reduce an entire thickness of the backlight module 100.

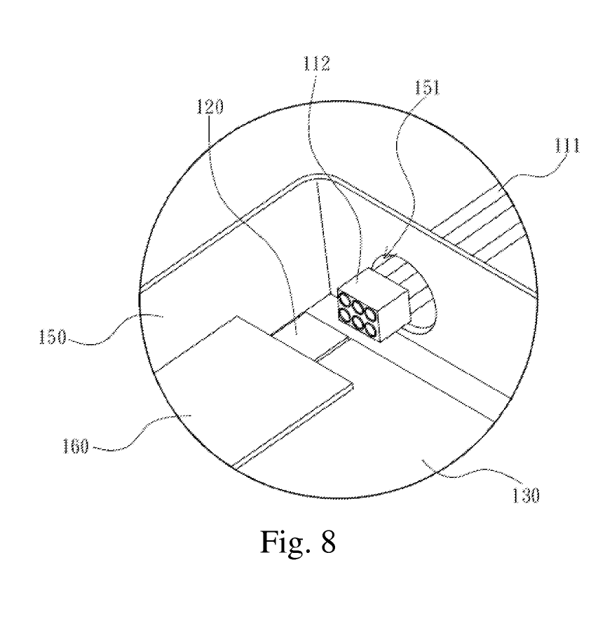

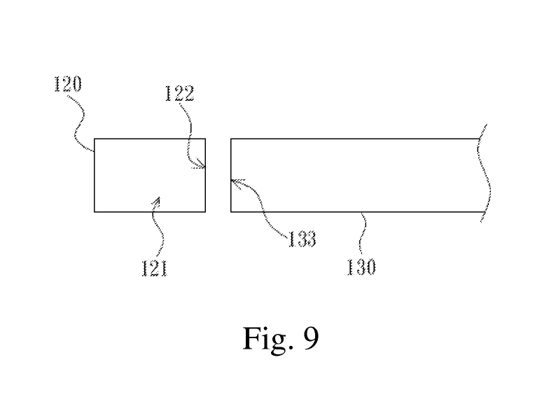

Referring to FIG. 8 and FIG. 9, FIG. 8 is an enlarged view showing a portion of the backlight module according to another embodiment of the present invention, and FIG. 9 is a schematic diagram showing the light guide bar and the light guide plate according to another embodiment of the present invention. In another embodiment, the light-incident surface 121 of the light guide bar 120 may be rectangular. In this case, the light-emitting ends of the plurality of optical fibers 111 facing the light-incident surface 121 can be arranged in a rectangular manner for correspondingly transmitting the light rays to the rectangular light-incident surface 121. Moreover, a thickness of the light guide plate 130 may be equal to the height of the light-incident surface 121 (or the light-emitting surface 122) of the light guide bar 120. In this case, the height of the light guide bar 120 can be reduced for reducing the entire thickness of the backlight module 100.

Referring to FIG. 3 again, the light guide plate 130 of the present embodiment is disposed at one side of the light guide bar 120. The light guide plate 130 may be made by the method of injection molding, and the material thereof may be photo-curable resin, polymethylmethacrylate (PMMA) or polycarbonate (PC) for guiding the light rays transmitted by the optical fibers 111 toward the liquid crystal display panel. The light guide plate 130 includes a light output surface 131, a light reflection surface 132 and a light input side surface 133. The light output surface 131 is formed on one side of the light guide plate 130 and faces to the liquid crystal display panel. The light output surface 131 may include a cloudy surface or a plurality of scattering patterns to uniform the light rays outputted from the light guide plate 130, thereby preventing the situation of mura. In another embodiment, the light output surface 131 may include a plurality of protruding structures (not shown) to modify the direction of the light rays, thereby condensing the light rays and enhancing a brightness thereof, wherein the protruding structures may be prism-shaped structures or semicircle-shaped structures. The light reflection surface 132 is formed opposite to the light output surface 131 for reflecting light thereto. In the present embodiment, the light reflection surface 132 of the light guide plate 130 is parallel to the light output surface 131. The light reflection surface 132 may have a plurality of light guiding structures (not shown) formed thereon to guide light to the light output surface 131. The light guiding structures of the light reflection surface 132 may be a continuous V-shaped structure, i.e. V-cut structures, a cloudy surface or scattering patterns, thereby guiding the light rays transmitted by the optical fibers 111 to be outputted from the light output surface 131. The light input side surface 133 may be formed on one side or two opposite sides of the light guide plate 130 and face the light-emitting surface 122 of the light guide bar 120 for allowing the light rays transmitted by the optical fibers 111 to be transmitted from the light guide bar 120 to the light guide plate 130. The light input side surface 133 may have V-shaped structures (V-cut structures), S-shaped structures or a rough surface structure (not shown) to raise light incidence efficiency and light coupling efficiency.

Referring to FIG. 1 again, the light collector 140 can be disposed outside the display apparatus (such as outdoors or indoors) and connected to one end of the optical fibers 111 for collecting the ambient light, such as sunlight. The light collector 140 can include a base 141, an optical lens 142, a photo-sensor 143 and a cover 144. The optical lens 142 and the photo-sensor 143 can be disposed on the base 141. The optical lens 142 is configured to collect the ambient light and provide the collected light rays to input ends 116 of the optical fibers 111. The photo-sensor 143 is configured to detect the ambient light for controlling the base 141 to rotate according an ambient light source, such as sun, thereby improving a light collection efficiency. The cover 144 is configured to encapsulate the optical lens 142 and the photo-sensor 143. Furthermore, the cover 144 may have an ultraviolet ray filter layer (not shown) to filter ultraviolet rays in the ambient light rays.

Referring to FIG. 1 again, in the present embodiment, the back bezel 150 may be made of an opaque material, such as plastic, metal or any combination material thereof for carrying the light guide bar 120 and the light guide plate 130, wherein the back bezel 150 may have a through hole 151, and the through hole 151 is formed positioned to the light-incident surface 121 of the light guide bar 120 for allowing the optical fibers 111 to pass through the back bezel 150.

When using the backlight module of the present embodiment to provide a backlight source, the optical fibers 111 can transmit the light rays (such as sunlight) collected by the light collector 140 to the light guide plate 130 through the light guide bar 120, so as to form a plane light source. More specifically, the light rays collected by the light collector 140 can be transmitted to the light guide bar 120 by the optical fibers 111, and the total reflection of the light rays is formed in the light guide bar 120. When the light rays are transmitted to the scattering patterns 123 of the light guide bar 120, the scattering patterns 123 can destroying the total reflection of the light rays therein, such that the light rays can be outputted from the light-emitting surface 122 to the light input side surface 133 of the light guide plate 130. The backlight module 100 can use the ambient light to provide the backlight source, thereby greatly reducing an energy consumption of light sources. Moreover, the ambient light (such as sunlight) can have a wide color gamut, and thus the display apparatus using the backlight module 100 can display images of real color for improving a display quality thereof. In addition, the optical fibers 111 are connected to the light-incident surface 121 of the light guide bar 120, so as to reduce an amount of the optical fibers 111 for reducing the cost of the optical fibers 111. Moreover, the light rays transmitted by the optical fibers 111 can be pre-mixed by the light guide bar 120, thereby reducing a light mixing distance of the light guide plate 130. Thus, the light rays transmitted by the optical fibers 111 can be used more efficiently, and a slim-bezel design can be achieved.

As described above, the backlight module and the display apparatus of the present invention can collect the ambient light rays to form the backlight source, thereby greatly reducing an energy consumption of light sources, as well as improving an image color performance and a display quality of the display apparatus. Furthermore, with the use of the light guide bar of the present invention, the amount of the optical fibers can be reduced to reduce the cost thereof, and a high efficiency for light energy utilization and the slim-bezel design can be achieved.

The present invention has been described with a preferred embodiment thereof and it is understood that many changes and modifications to the described embodiment can be carried out without departing from the scope and the spirit of the invention that is intended to be limited only by the appended claims.

1. A backlight module, comprising:
a light collector configured to collect ambient light rays;
at least one optical fiber connected to the light collector;
a light guide bar connected to the optical fiber; and
a light guide plate disposed at one side of the light guide bar;
wherein the at least one optical fiber comprises a plurality of optical fibers, and light-emitting ends of the optical fibers are held to be positioned to a light-incident surface of the light guide bar by a holder, and the light guide bar includes a light-emitting surface and scattering patterns, and the light-emitting surface faces a light input side surface of the light guide plate, and the scattering patterns are formed on a side surface of the light guide bar and opposite to the light-emitting surface.

2. The backlight module according to claim 1, wherein the light guide bar is disposed in a short-axis direction or a longitudinal direction of the light guide plate.

3. The backlight module according to claim 1, further comprising a reflective cover configured to cover the light guide bar and to expose the light-incident surface and the light-emitting surface of the light guide bar.

4. The backlight module according to claim 1, wherein the light-incident surface is circular, and the light-emitting ends of the plurality of optical fibers are arranged in a circular manner.

5. The backlight module according to claim 1, wherein the light-incident surface is rectangular, and the light-emitting ends of the plurality of optical fibers are arranged in a rectangular manner.

6. The backlight module according to claim 1, wherein a thickness of the light guide plate is less than a diameter or height of the light-incident surface of the light guide bar.

7. The backlight module according to claim 1, wherein a thickness of the light guide plate is equal to a height of the light-incident surface of the light guide bar.

8. A backlight module, comprising:
a light collector configured to collect ambient light rays;
at least one optical fiber connected to the light collector;
a light guide bar connected to the optical fiber; and
a light guide plate disposed at one side of the light guide bar.

9. The backlight module according to claim 8, wherein the at least one optical fiber comprises a plurality of optical fibers, and light-emitting ends of the optical fibers are held to be positioned to a light-incident surface of the light guide bar by a holder.

10. The backlight module according to claim 8, wherein the light guide bar is disposed in a short-axis direction or a longitudinal direction of the light guide plate.

11. The backlight module according to claim 8, wherein the light guide bar includes a light-emitting surface and scattering patterns, and the light-emitting surface faces a light input side surface of the light guide plate, and the scattering patterns are formed on a side surface of the light guide bar and opposite to the light-emitting surface.

12. The backlight module according to claim 8, further comprising a reflective cover configured to cover the light guide bar and to expose a light-incident surface and a light-emitting surface of the light guide bar.

13. The backlight module according to claim 8, wherein the at least one optical fiber comprises a plurality of optical fibers, and a light-incident surface of the light guide bar is circular, and light-emitting ends of the plurality of optical fibers are arranged in a circular manner.

14. The backlight module according to claim 8, wherein the at least one optical fiber comprises a plurality of optical fibers, and a light-incident surface of the light guide bar is rectangular, and light-emitting ends of the plurality of optical fibers are arranged in a rectangular manner.

15. The backlight module according to claim 8, wherein a thickness of the light guide plate is less than a diameter or height of a light-incident surface of the light guide bar.

16. The backlight module according to claim 8, wherein a thickness of the light guide plate is equal to a height of a light-incident surface of the light guide bar.

17. A display apparatus, comprising:
a display panel; and
a backlight module comprising:
a light collector configured to collect ambient light rays;
at least one optical fiber connected to the light collector;
a light guide bar connected to the optical fiber; and
a light guide plate disposed at one side of the light guide bar.
